(19) United States
(12) Patent Application Publication
(10) Pub. No.: US 2018/0124418 A1
(43) Pub. Date: May 3, 2018

(54) MOTION COMPENSATION USING MACHINE LEARNING

(71) Applicant: Magic Pony Technology Limited, London (GB)

(72) Inventors: Sebastiaan Van Leuven, London (GB); Jose Caballero, London (GB); Zehan Wang, London (GB); Robert David Bishop, London (GB)

(21) Appl. No.: 15/855,468

(22) Filed: Dec. 27, 2017

Related U.S. Application Data
(63) Continuation of application No. PCT/GB2017/000057, filed on Apr. 13, 2017.

(30) Foreign Application Priority Data
Apr. 15, 2016 (GB) 1606681.3

(51) Int. Cl. H04N 19/51; H04N 19/593; H04N 19/159

(52) U.S. Cl. CPC H04N 19/51; G06T 9/002; H04N 19/159; H04N 19/593

(57) ABSTRACT

Use of machine learning to improve motion compensation in video encoding. According to a first aspect, there is provided a method for motion compensation in video data using hierarchical algorithms, the method comprising the steps of: receiving one or more original blocks of video data and one or more reference blocks of video data; determining, using one or more hierarchical algorithms, one or more predicted blocks of video data from the one or more reference blocks of video data; and calculating one or more residual blocks of video data from the one or more predicted blocks of video data and the one or more original blocks of video data.

### CROSS-REFERENCE TO RELATED APPLICATIONS

This application is a continuation of, and claims priority to, International Patent Application No. PCT/GB2017/000057, filed on Apr. 13, 2017, and entitled “MOTION COMPENSATION USING MACHINE LEARNING,” which claims priority to United Kingdom Patent Application No. GB 1606681.3, filed on Apr. 15, 2016, the contents of both of which are incorporated herein by reference in their entireties.

### FIELD

The present disclosure relates to motion compensation in video encoding. For example, the present disclosure relates to the use of machine learning to improve motion compensation in video encoding.

### BACKGROUND

### Video Compression

FIG. 1 illustrates the generic parts of a typical video encoder process.

Video compression technologies reduce information in pictures by identifying and reducing redundancies available in the video data. This can be achieved by predicting the image (or parts thereof) from neighbouring data within the same frame (intraprediction) or from data previously signalled in other frames (interprediction). Interprediction techniques exploit similarities between pictures in a temporal dimension. Examples of such video techniques include, but are not limited to, MPEG2, H.264, HEVC, VP8, VP9, Thor, and Daala.

In general, video compression techniques comprise the use of different modules. To reduce the amount of data in a video, a residual signal is created based on the predicted samples. Intra-prediction 121 uses previously decoded sample values of neighbouring samples to assist in the prediction of current samples. The residual signal is transformed by a transform module 103 (typically, Discrete Cosine Transform or Fast Fourier Transforms are used). This transformation allows the encoder to remove data in high frequency bands, where humans notice artefacts less easily, through quantisation 105. The resulting data and all syntactical data is entropy encoded 125, which is a lossless data compression step. The quantized data is reconstructed through an inverse quantisation 107 and inverse transformation 109 step. By adding the predicted signal, the input visual data 101 is re-constructed 113. To improve the visual quality, filters, such as a deblocking filter 111 and a sample adaptive offset filter 127 can be used. The reconstructed picture 113 is stored for future reference in a reference picture buffer 115 to allow exploiting the difference static similarities between two pictures. The motion estimation process 117 evaluates one or more candidate blocks by minimizing the distortion compared to the current block. One or more blocks from one or more reference pictures are selected. The displacement between the current and optimal block(s) is used by the motion compensation 119, which creates a prediction for the current block based on the vector. For interpredicted pictures, blocks can be either intra- or interpredicted or both.

Interprediction exploits redundancies between frames of visual data. Reference frames are used to reconstruct frames that are to be displayed, resulting in a reduction in the amount of data required to be transmitted or stored. The reference frames are generally transmitted before the frames of the image to be displayed. However, the frames are not required to be transmitted in display order. Therefore, the reference frames can be prior to or after the current image in display order, or may even never be shown (i.e., an image encoded and transmitted for referencing purposes only). Additionally, interprediction allows the use of multiple frames for a single prediction, where a weighted prediction, such as averaging, is used to create a predicted block.

FIG. 2 illustrates a schematic overview of the Motion Compensation (MC) process part of the interprediction.

Motion compensation is part of the performance of video compression. In motion compensation, reference blocks 201 from reference frames 203 are combined to produce a predicted block 205 of visual data. This predicted block 205 of visual data is subtracted from the corresponding input block 207 of visual data in the frame currently being encoded 209 to produce a residual block 211 of visual data. It is the residual block 211 of visual data, along with the identities of the reference blocks 201 of visual data, which are used by a decoder to reconstruct the encoded block 207 of visual data. In this way the amount of data required to be transmitted to the decoder is reduced.

The Motion Compensation process has as input a number of pixels of the original image, referred to as a block, and one or more areas consisting of pixels (or subpixels) within the reference images that have a good resemblance with the original image. The MC subtracts the selected block of the reference image from the original block. To predict one block, the MC can use multiple blocks from multiple reference frames, through a weighted average function the MC process yields a single block that is the predictor of the block from the current frame. The frames transmitted prior to the current frame can be located before and/or after the current frame in display order.

The closer the predicted block 205 is to the corresponding input block 207 in the picture being encoded 209, the better the compression efficiency will be, as the residual block 211 will not be required to contain as much data. Therefore, matching the predicted block 205 as closely as possible to the current picture can provide good encoding performance. Consequently, the most optimal, or closely matching, reference blocks 201 in the reference pictures 203 can be found. However, a process of finding the optimal reference blocks, better known as motion estimation, is not defined or specified by the MPEG standard.

FIG. 3 illustrates a visualisation of the motion estimation process.

An area 301 of a reference frame 303 is searched for a data block 305 that matches the block currently being encoded 307 most closely, and a motion vector 309 can be determined that relates the position of this reference block 305 to the block currently being encoded 307. The motion estimation will evaluate a number of blocks in the reference frame. By applying a translation between the frame currently being encoded 311 and the reference frame 303, any candidate block in the reference picture can be evaluated. In principle, any block of pixels in the reference image can be evaluated to find the most optimal reference block. However, this may be computationally expensive, and some implementations can optimise this search by limiting the number of blocks to be evaluated from the reference picture. Therefore, the most optimal reference block might not be found.

When the most optimal block is found, or at least a block that is sufficiently close to the current block, the motion compensation creates the residual block, which is used for transformation and quantisation. The difference in position between the current block and the optimal block in the reference image is signalled in the form of a motion vector, which also indicates the identity of the reference image being used as a reference.

Motion estimation and compensation are part of video encoding. In order to encode a single frame, a motion field has to be estimated that will describe the displacement undergone by the spatial content of that frame relative to one or more reference frames. Ideally, this motion field would be dense, such that each pixel in the frame has an individual correspondence in the one or more reference frames. The encoding of dense motion fields is usually referred to as optical flow, and different methods have been suggested to estimate it. However, obtaining accurate pixelwise motion fields may be computationally challenging and expensive, hence in practice encoders can resort to block matching algorithms that look for correspondences for blocks of pixels instead. This, in turn, can limit the compression performance of the encoder.

FIG. 4 illustrates a generic decoder.

An encoded bit stream 401 containing encoded residual blocks of video data is received by the decoder, possibly having been transmitted over a network. The encoded bit stream 401 undergoes entropy decoding 403, followed by inverse quantisation 405 and inverse transformation 407 to generate a residual block of video data. The decoder reconstructs the prediction based on the signalled inter- or intraprediction 409 mode. Therefore, either the previously decoded and reconstructed reference frame has to be available (interprediction) or the pixel values of neighbouring pixels. For intrapredicted blocks in interpredicted frames, this means that the motion compensation 411 for the interpredicted regions is performed before the current intrapredicted block can be decoded.

The motion compensation 411 process at the decoder can be essentially the reverse of the motion compensation process at the encoder. A predicted block of visual data is generated from the reference frames identified to the decoder in the encoded bit stream 401 by means of a weighted average. This predicted block of visual data is then added to the decoded residual block of visual data in order to reconstruct the original block of video data that was encoded at the encoder. This process is repeated until all of the interpredicted blocks in the encoded picture have been reconstructed.

After the original picture has been reconstructed, it is input into a deblocking filter 413 and, in some encoding standards, a Sample Adaptive Offset filter 415. These smooth out blocking and ringing artefacts introduced by the block wise interprediction and intraprediction processes.

The final reconstructed frame 417 is then output.

### Machine Learning Techniques

Machine learning is the field of study where a computer or computers learn to perform classes of tasks using the feedback generated from the experience or data gathered that the machine learning process acquires during computer performance of those tasks.

Typically, machine learning can be broadly classed as supervised and unsupervised approaches, although there are particular approaches such as reinforcement learning and semi-supervised learning which have special rules, techniques and/or approaches. Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and typically uses unlabelled data sets.

Reinforcement learning is concerned with enabling a computer or computers to interact with a dynamic environment, for example when playing a game or driving a vehicle.

Various hybrids of these categories are possible, such as “semi-supervised” machine learning where a training data set has only been partially labelled.

For unsupervised machine learning, there is a range of possible applications such as, for example, the application of computer vision techniques to image processing or video enhancement. Unsupervised machine learning is typically applied to solve problems where an unknown data structure might be present in the data. As the data is unlabelled, the machine learning process is required to operate to identify implicit relationships between the data for example by deriving a clustering metric based on internally derived information. For example, an unsupervised learning technique can be used to reduce the dimensionality of a data set and attempt to identify and model relationships between clusters in the data set, and can for example generate measures of cluster membership or identify hubs or nodes in or between clusters (for example using a technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example where only a subset of the data is labelled. Semi-supervised machine learning makes use of externally provided labels and objective functions as well as any implicit data relationships.

When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training, and could also mean that the machine learning process does not converge to good solutions for all or specific examples). The user must also determine the desired structure of the learned or generalised function, for example whether to use support vector machines or decision trees.

The use of unsupervised or semi-supervised machine learning approaches are sometimes used when labelled data is not readily available, or where the system generates new labelled data from unknown data given some initial seed labels.

### SUMMARY

Some aspects and/or embodiments seek to provide a method of motion compensation that utilises hierarchical algorithms to improve the generation of a predicted block of visual data.

According to a first aspect, there is provided a method for motion compensation in video data using hierarchical algorithms, the method comprising the steps of: receiving one or more original blocks of video data and one or more reference blocks of video data; determining, using one or more hierarchical algorithms, one or more predicted blocks of video data from the one or more reference blocks of video data; and calculating one or more residual blocks of video data from the one or more predicted blocks of video data and the one or more original blocks of video data.

According to a second aspect, there is provided a method for motion compensation in video data using hierarchical algorithms, the method comprising steps of: receiving one or more residual blocks of video data and one, one or more reference blocks of video data; determining, using one or more hierarchical algorithms, one or more predicted blocks of video data from the two or more reference blocks of video data; and calculating one or more original blocks of video data from the one or more predicted blocks of video data and the one or more residual blocks of video data.

In an embodiment, the use of a hierarchical algorithm to determine a predicted block of video data from one or more reference blocks can provide a predicted block of video data that is more similar to an original, input block being encoded than a predicted block determined solely by a weighted average. The residual block of data required to reconstruct the input frame from the reference frames can then be smaller, reducing the resulting bit rate of the encoded bit stream. When reconstructing the original video data, knowledge of the hierarchical algorithms used in the encoding phase can be used to determine a predicted block to which the calculated residual block can be added to reconstruct the original frame.

Optionally, the method further comprises the additional step of receiving metadata identifying the one or more hierarchical algorithms to be used.

By transmitting metadata to the decoder allowing the required hierarchical algorithm or algorithms to be identified, the decoder is not required to identify these itself, resulting in an increase in computational efficiency.

Optionally, the one or more hierarchical algorithms are selected from a library of hierarchical algorithms based on properties of the one or more of reference blocks of video data.

By selecting a content specific hierarchical algorithm from a library of pre-trained hierarchical algorithms based on properties of the reference blocks the efficiency of the motion estimation process can be increased when compared to using a generic hierarchical algorithm on all types of reference block. It also allows for different hierarchical algorithms to be used for different blocks in the same reference image.

Optionally, the one or more reference blocks of video data are determined from one or more reference frames of video data.

Determining the reference blocks of video data from known reference frames of video data reduces the amount of data required to be encoded, as only a reference to the known reference frame, and the location of the reference block within it, need to be encoded.

Optionally, a motion vector is used to determine the one or more reference blocks of video data from the one or more reference frames of video data.

A motion vector can be estimated in a motion estimation process, which relates the position of the reference block in the reference frame to the position of the original input block in an input frame.

Optionally, the one or more reference blocks of video data are selected using at least one of: translational motion estimation; affine motion estimation; style transform, or warping.

By allowing the reference block to be selected using a variety of methods, the flexibility of the motion compensation process can be increased. The reference block can then be related to the original block by more than just a translation, for example a scaling or rotation could also be used.

Optionally, the one or more reference block of video data comprises a plurality of reference blocks of visual data.

Optionally, the step of determining the one or more predicted blocks of visual data comprises combining, using the one or more hierarchical algorithms, at least two of the plurality of reference blocks of video data.

Using more than one reference block to generate a predicted block of visual data can increase the match between the original input block and the generated predicted block.

Optionally, at least two of the plurality of reference blocks of video data are each selected from a different reference frame of video data.

Selecting reference blocks from multiple different frames of video data allows the hierarchical algorithms to produce predicted block using reference blocks that contain different content that may not be present in a single reference frame.

Optionally, the one or more hierarchical algorithms comprise two or more separate hierarchical algorithms that are applied to each of the plurality of reference blocks of video data to transform the one or more of reference blocks of video data to the one or more predicted blocks of video data.

By applying separate algorithms to each of the reference blocks, the size of the respective algorithms can be reduced and their efficiency increased, as they are not required to process multiple reference blocks simultaneously. It also allows for a modular motion compensation process. Optionally, at least two of the separate hierarchical algorithms applied to each of the plurality of reference blocks of video data are identical.

Using the same hierarchical algorithm on some of the reference blocks reduces the total number of hierarchical algorithms required to be stored at the encoder or decoder.

Optionally, at least two of the separate hierarchical algorithms applied to each of the plurality of reference blocks of video data are different.

In general, different reference blocks of visual data will have different optimal hierarchical algorithms for the motion compensation process. By using different hierarchical algorithms on reference blocks, the efficiency of the process can be increased, as a more optimal hierarchical algorithm can be used for each block.

Optionally, the one or more separate hierarchical algorithms each are chosen from a library of hierarchical algorithms based on properties of the plurality of reference blocks of video data.

Choosing the hierarchical algorithms from a library of pre-trained hierarchical algorithms based on properties of the plurality of reference blocks allows content specific hierarchical algorithms to be used that has been substantially optimised for use with reference blocks with those properties. These properties can include the content type, the position of the reference block within the reference frame from which it was taken and the resolution of the frame from which it was taken. It allows for an adaptive transformation of the reference blocks to improve the prediction accuracy, and for different hierarchical algorithms to be used for different blocks in the same reference image. Furthermore, the selection of the hierarchical algorithm can be based on the temporal position of the reference frame from which the reference blocks have been selected.

Optionally, at least one further hierarchical algorithm is applied to an output of the one or more separate hierarchical algorithms to determine the predicted block of visual data.

A further hierarchical algorithm can be applied to the output of the separate hierarchical algorithms, either after a weighted average is taken of the outputs or not, to further enhance the accuracy of the predicted block of visual data. This further hierarchical algorithm can compensate for the relative simplicity of the separate hierarchical algorithms applied to the reference blocks individually.

Optionally, the step of determining the one or more predicted blocks of video data comprises a step of transforming, using the one or more hierarchical algorithms, the one or more reference blocks of video data to one or more transformed blocks of video data.

Optionally, the predicted block of video data is determined from the transformed block of video data.

Optionally, one or more additional hierarchical algorithms are used to determine the predicted block of video data from the transformed block of video data.

Transforming the reference blocks to an intermediate block before generating the predicted block can simplify the process, especially when multiple reference blocks are used.

Optionally, the one or more hierarchical algorithms were developed using a learned approach.

Optionally, the learned approach comprises training the hierarchical algorithm on one or more known predicted blocks of video data and one or more known reference blocks of video data to minimise a difference between the outputs of the hierarchical algorithm and the known original blocks of video data.

By training the hierarchical algorithm on sets of known reference and predicted blocks, the hierarchical algorithm can be substantially optimised for the motion compensation process. Using machine learning to train the hierarchical algorithms can result in more efficient and faster hierarchical algorithms than otherwise.

Optionally, the one or more hierarchical algorithms comprise at least one of: a nonlinear hierarchical algorithm; a neural network; a convolutional neural network; a layered algorithm; a recurrent neural network; a long short-term memory network; a multi-dimensional convolutional network; a memory network; or a gated recurrent network.

The use of any of a non-linear hierarchical algorithm; neural network; convolutional neural network; recurrent neural network; long short-term memory network; multi-dimensional convolutional network; a memory network; or a gated recurrent network allows a flexible approach when generating the predicted block of visual data. The use of an algorithm with a memory unit such as a long short-term memory network (LSTM), a memory network or a gated recurrent network can keep the state of the predicted blocks from motion compensation processes performed on the same original input frame. The use of these networks can improve computational efficiency and also improve temporal consistency in the motion compensation process across a number of frames, as the algorithm maintains some sort of state or memory of the changes in motion. This can additionally result in a reduction of error rates.

Optionally, the method is performed at a node within a network.

Optionally, the method is performed as part of a video encoding or decoding process.

Optionally, the one or more predicted blocks of visual data is a single predicted block of visual data.

According to a third aspect, there is provided a method of enhancing reference frames of video data for use in motion compensation using hierarchical algorithms, the method comprising the steps of: receiving one or more reference frames of video data from a reference buffer; transforming, using one or more hierarchical algorithms, one or more reference blocks of video data in the one or more reference frames of video data to produce one or more transformed frames of video data, such that the transformed frames of video data are enhanced for motion compensation; and outputting the one or more transformed frames of video data.

Transforming reference frames of video data prior to the motion compensation process can allow the reference frames to be substantially optimised or enhanced for the generation of predicted blocks of visual data or for a motion estimation process. This can result in a closer match between the predicted block of visual data and the original input block of visual data, meaning that the residual block of visual data calculated in the motion compensation process will be smaller.

Optionally, a plurality of hierarchical algorithms is applied to the one or more reference frames of video data.

Applying multiple hierarchical algorithms to the reference frame can generate multiple enhanced reference frames for use in motion compensation.

Optionally, two or more hierarchical algorithms from the plurality of hierarchical algorithms share one or more layers.

By performing common functions between the plurality of hierarchical algorithms in shared layers, the computational efficiency of the process can be enhanced.

Optionally, the transformed frames of video data are used in a motion estimation process.

Using the enhanced frames in the motion estimation process can decrease the computational power required to determine a motion estimation vector.

Optionally, the transformed frames of video data are used in a motion compensation process.

Using the enhanced frames in the motion compensation process can decrease the computational power required to determine a predicted block of visual data.

Optionally, the one or more hierarchical algorithms comprise at least one of: a nonlinear hierarchical algorithm; a neural network; a convolutional neural network; a layered algorithm; a recurrent neural network; a long short-term memory network; a multi-dimensional convolutional network; a memory network; or a gated recurrent network.

The use of any of a non-linear hierarchical algorithm; neural network; convolutional neural network; recurrent neural network; long short-term memory network; multi-dimensional convolutional network; a memory network; or a gated recurrent network allows a flexible approach when generating the predicted block of visual data. The use of an algorithm with a memory unit such as a long short-term memory network (LSTM), a memory network or a gated recurrent network can keep the state of the previously enhanced frames of video data to assist in the enhancement of the current reference frame. The use of these networks can improve computational efficiency and also improve temporal consistency in the motion compensation process across a number of frames, as the algorithm maintains some sort of state or memory of the changes in motion. This can additionally result in a reduction of error rates.

Optionally, the method is performed as part of a video encoding process.

Optionally, the method is performed at a network node within a network.

Optionally, the one or more hierarchical algorithms were developed using a learned approach.

Optionally, the hierarchical algorithm is trained on one or more sub-optimal reference frames and corresponding known reference frames to produce a mathematically optimised reference picture.

By training the hierarchical algorithm on sets of known optimal reference frames and sub-optimal reference frames, the hierarchical algorithm can be substantially optimised for enhancing the reference frames. Using machine learning to train the hierarchical algorithms can result in more efficient and faster hierarchical algorithms than otherwise.

Herein, the word picture is preferably used to connote an array of picture elements (pixels) representing visual data such as: a picture (for example, an array of luma samples in monochrome format or an array of luma samples and two corresponding arrays of chroma samples in, for example, 4:2:0, 4:2:2, and 4:4:4 colour format); a field or fields (e.g. interlaced representation of a half frame: top-field and/or bottom-field); or frames (e.g. combinations of two or more fields).

Herein, the word block is preferably used to connote a group of pixels, a patch of an image comprising pixels, or a segment of an image. This block may be rectangular, or may have any form, for example comprise an irregular or regular feature within the image. The block may potentially comprise pixels that are not adjacent.

### BRIEF DESCRIPTION OF DRAWINGS

Embodiments will now be described, by way of example only and with reference to the accompanying drawings having like-reference numerals, in which:

FIG. 1 illustrates an example of a generic encoder;

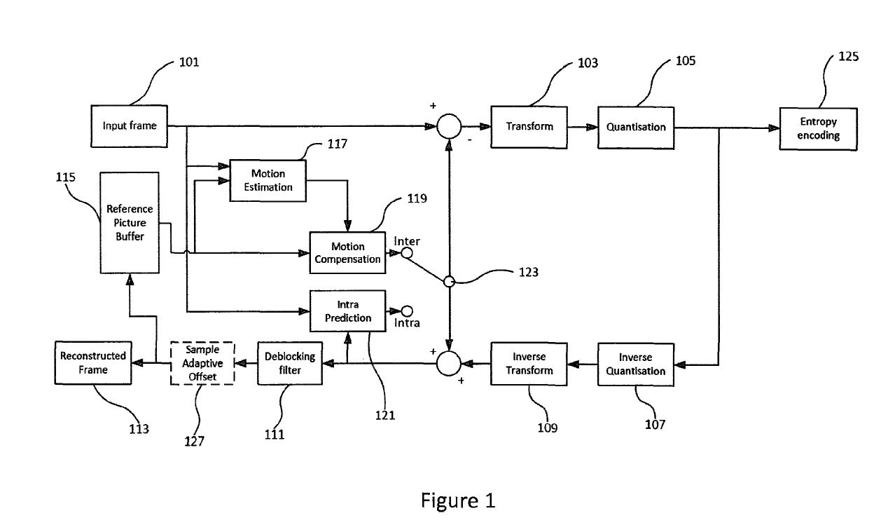

FIG. 2 illustrates an example of a generic decoder;

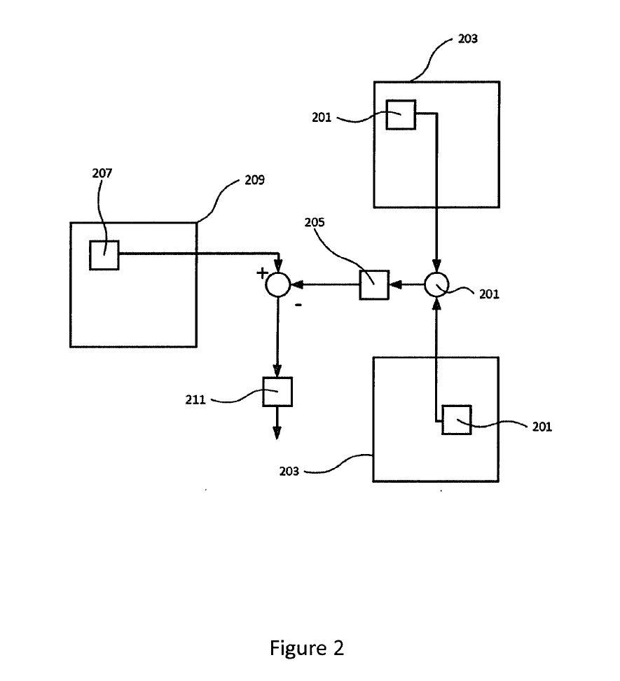

FIG. 3 illustrates an example of a generic motion compensation process;

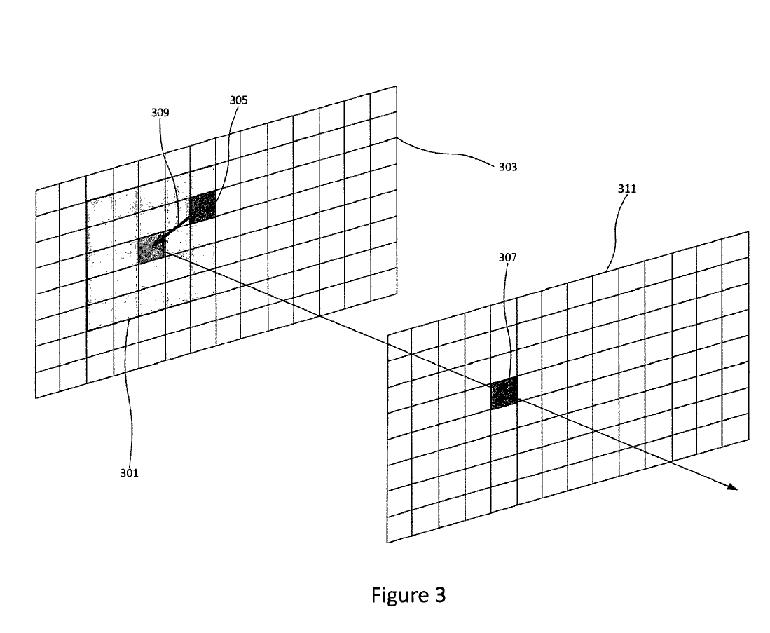

FIG. 4 illustrates an example of a motion estimation process;

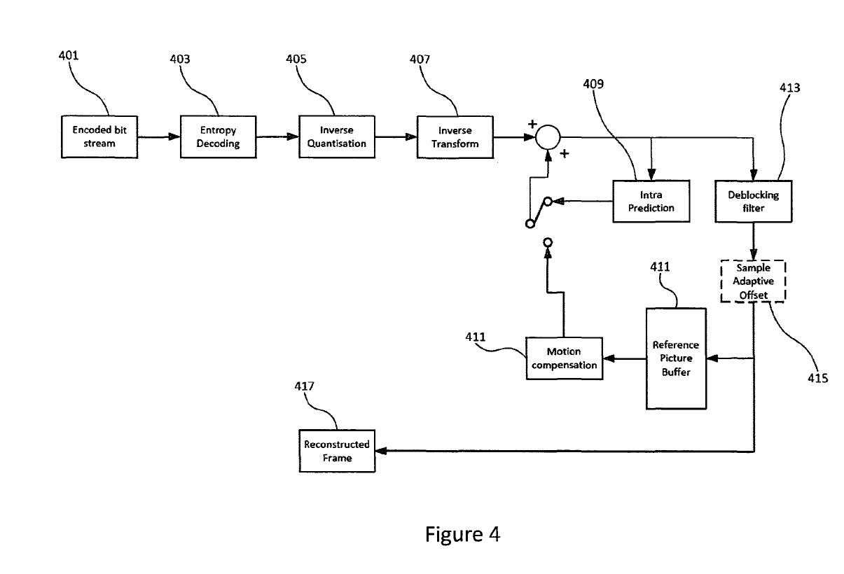

FIG. 5 illustrates an embodiment of a motion compensation process using a hierarchical algorithm;

FIG. 6 illustrates an embodiment of a motion compensation process using two hierarchical algorithms

FIG. 7 illustrates an embodiment of a motion compensation process using three hierarchical algorithms;

FIG. 8 illustrates an embodiment of a motion compensation process used in a decoder that uses hierarchical algorithms;

FIG. 9 illustrates an embodiment of a motion compensation process using multiple hierarchical algorithms prior to the interprediction process; and

FIG. 10 illustrates an apparatus comprising a processing apparatus and memory according to an exemplary embodiment

### DETAILED DESCRIPTION

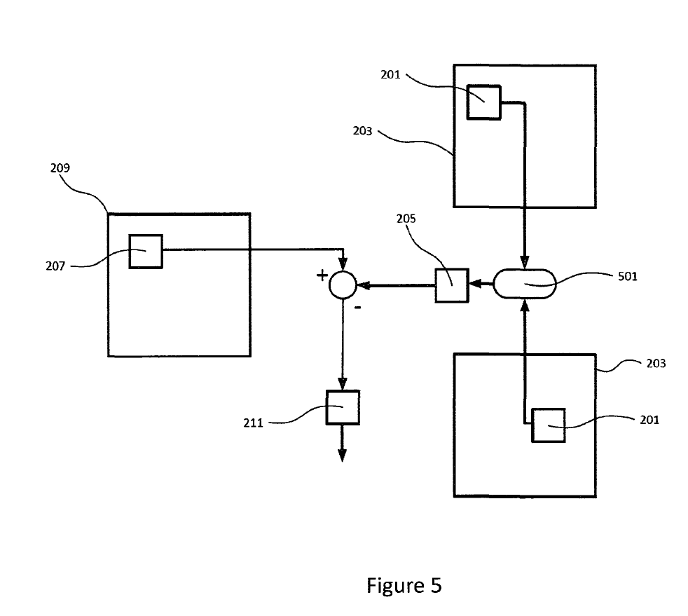

Referring to FIG. 5, an exemplary embodiment will now be described.

FIG. 5 illustrates an embodiment of a motion compensation process using a hierarchical algorithm. An input block 207 of video data from an input frame 209 is selected, and one or more reference blocks 201 of video data from one or more reference frames 203 are selected based on their similarity to the input block 207. In the embodiment shown, two reference frames 203 are used, though it is possible that only a single reference frame is used, or that more than two are used. In the case of a single reference frame being used, multiple reference blocks can be selected from the same frame, or only a single reference block can be selected. The reference block or blocks 201 are selected using a motion estimation process, which can relate the reference blocks 201 to the input block 207 by any of a simple translation, an affine transformation or a warping. The selected reference block or blocks 201 are used as inputs into a hierarchical algorithm 501 that generates a predicted block 205 of visual data from them. This predicted block 205 is subtracted from the input block 207 to determine a residual block of visual data 211.

The hierarchical algorithm 501 acts on the selected reference blocks 201 to transform them to a predicted block 205 of visual data that can substantially be optimised such that the similarity between the original, input block 207 and the predicted block 205 is reduced when compared to just a weighted average of the selected reference blocks 201 (when two or more reference blocks are used) or an untransformed single reference block.

The hierarchical algorithm 501 can be selected from a library of hierarchical algorithms that have been pre-trained on known reference blocks of visual data based on metric data or metadata relating to the input picture or block. The hierarchical algorithms are stored in the library after they have been trained along with metric data or metadata relating to the type of reference blocks on which they have been trained. The metric data can be, for example, the resolution of the picture or blocks, the content of the blocks or picture from which they are taken, or the position of the block within the picture from which it is taken. Additionally, the selection of the hierarchical algorithm can be dependent on the temporal position of the reference picture or pictures relative to the input picture.

For the training process, the input is an original block of video data and one or more reference blocks of video data that are assumed to be optimal. For training, the most optimal block can be found using an exhaustive block matching algorithm evaluating all possible positions for the current block within the reference picture. The algorithm can then be optimised to minimise the difference between its output and the original block of video data. Depending on the performance of the motion estimation process a new network could be trained. As different motion estimation process can yield different reference blocks, the network can be optimized for each implementation independently.

If no suitable hierarchical algorithm 501 is present in the library a generic pre-trained hierarchical algorithm can be used instead. If no such generic algorithm is available, then the standard weighted average method can be used instead.

The process is repeated for each block in the input image until all residual blocks 211 for the whole image are determined. It is not necessary that all residual blocks 211 of video data be calculated using the motion compensation process, as part of the interprediction. Some of the residual blocks 211 can instead be calculated using intraprediction or different techniques such as pallet modes.

Once determined, the residual blocks 211 for the input can be encoded and transmitted across a network to a decoding device comprising a decoder, along with data identifying the reference frames from which the reference blocks 201 were selected and the position of the reference blocks within those frames 203. The position of the reference blocks 201 within the reference frames 203 can be signalled across the network as a motion vector that was calculated during the motion estimation process. The reference frames 203 from which the corresponding reference blocks 201 are taken are transmitted across the network to the decoder prior to the transmission of the now encoded input frame, and stored in a reference buffer at the decoder.

The decoder receives the encoded bit stream containing the residual blocks 211 and metadata identifying the reference blocks 201, such as a motion vector and a reference to the corresponding reference frames 203. The identity of the hierarchical algorithms 501 used to generate the predicted blocks 205 from the reference blocks 201 are also determined by the decoder, for example from metric data associated with the reference blocks 201 or by receiving metadata in the encoded bit stream identifying the hierarchical algorithms 501 to be used, or by receiving metadata in the encoded bit stream which defines the values of a new hierarchical algorithm.

The determined hierarchical algorithm 501 is then applied to the identified reference block or blocks of visual data in order to determine a predicted block 205 of video data. The received residual block 211 of video data is added to this predicted block 205 of visual data to recreate the original block of visual data 207.

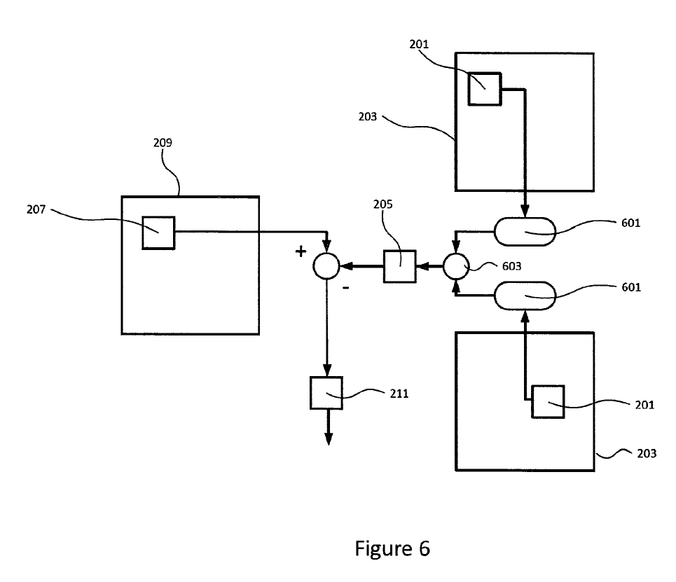

Another embodiment of the motion compensation process is illustrated in FIG. 6. In this embodiment, the reference blocks 201 selected during the motion estimation process are each input into a separate pre-trained hierarchical algorithm 601. The outputs of these hierarchical algorithms 601 are transformed blocks of visual data, which are then combined to produce a predicted block 205 using, for example, a weighted average 603. The predicted block 205 is then subtracted from the input block 207 to generate a residual block 211. The process is repeated until all the input blocks of an input frame 209 have been processed.

In some embodiments, the separate hierarchical algorithms 601 are identical, and can be selected based on properties on the input block 207 of visual data, such as its content, resolution and/or position in the input frame 209. In alternative embodiments, the separate hierarchical algorithms 601 can be generic pre-trained hierarchical algorithms.

As another example, the separate hierarchical algorithms 601 can be different from one another, and be selected from a library of hierarchical algorithms based on properties of the selected reference blocks 201. These can be, for example, the content of the reference frame 203, the resolution of the reference frame 203, the position of the reference block 201 with the reference frame 203 and/or the temporal distance in the video stream between the reference frames 203 and the input frame 209.

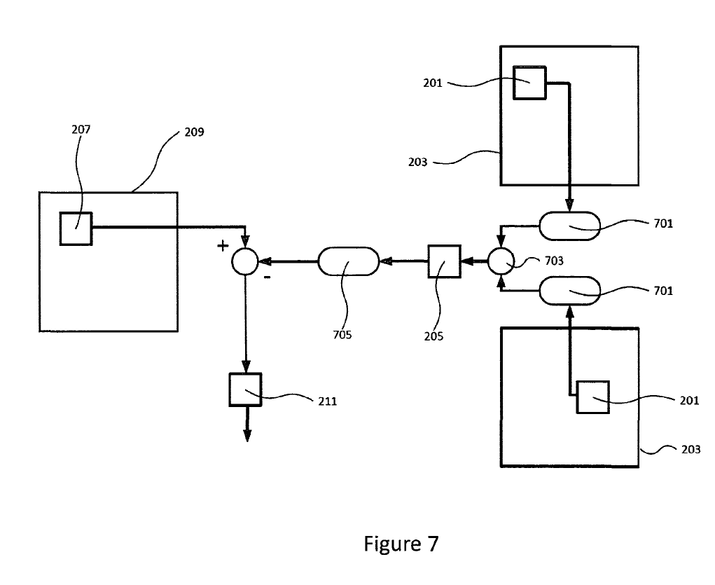

A further embodiment of the motion compensation process is illustrated in FIG. 7. In this embodiment, the reference blocks 201 selected during the motion estimation process are each input into a separate pre-trained hierarchical algorithm 701, as described in relation to FIG. 6. The outputs of these hierarchical algorithms 701 are transformed blocks of visual data, which are then combined to produce a combined block using, for example, a weighted average 703. The combined block is then used as an input for a further hierarchical algorithm 705 that outputs a predicted block 205. The predicted block 205 is then subtracted from the input block 207 to generate a residual block 211. The process is repeated until all the input blocks of an input frame 209 have been processed.

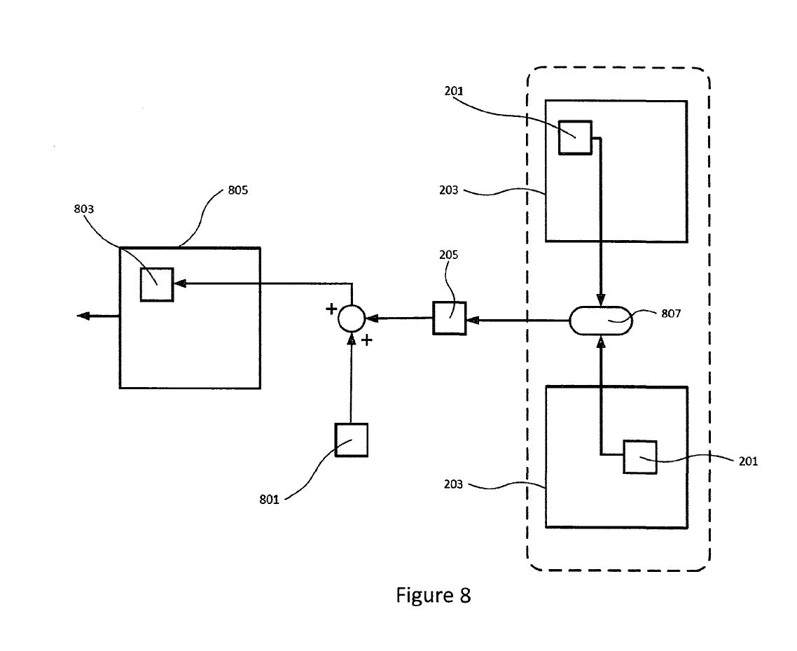

The above embodiments described in relation to FIGS. 5 to 7 can be applied in the case of the decoding motion compensation process, such as with some of the steps reversed. FIG. 8 illustrates an example of a decoding motion compensation process corresponding to the encoding motion compensation process described in relation to FIG. 5. In the decoding motion compensation process, the steps relating to the generation of the predicted block of data can remain the same as described in the embodiments relating to FIGS. 5 to 7. However, the decoder receives an encoded residual block 801 of visual data, which it adds to the predicted block 205 of visual data to reconstruct the original block 803 of visual data used in the encoding process. This is repeated for all the interpredicted blocks identified for use with this process in the encoded bit stream relating to a given picture 805 until the interpredicted parts of that picture have been reconstructed. While this diagram shows the generation of a predicted block 205 using the method described in relation to FIG. 5, any of the methods described in relation to FIGS. 5 to 7 can be used to generate the predicted block.

The hierarchical algorithms 807 used in the generation of the predicted block of visual data at the decoder are stored at the decoder in a library along with corresponding data, such as a reference number or metadata, relating to the hierarchical algorithms. The encoded bit stream can contain data identifying which of the hierarchical algorithms 807 are required to generate the predicted block 205, such as the reference number of the hierarchical algorithm in the library. As another example, this can be signalled in a sideband as, for instance, metadata in an app.

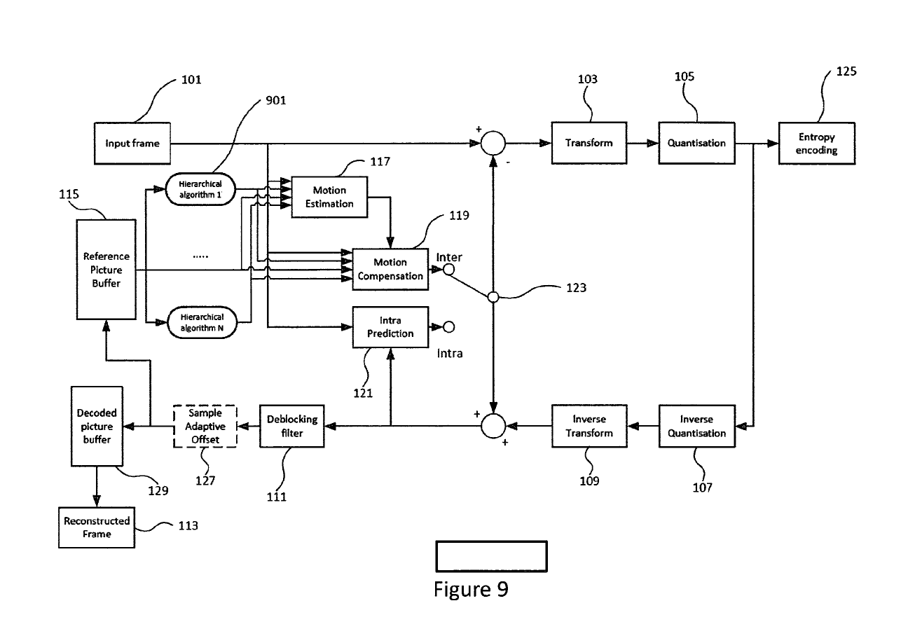

FIG. 9 illustrates an encoding process that uses hierarchical algorithms to pre-process pictures from a reference buffer before interprediction. In this process, reference pictures stored in a reference picture buffer 115 are input into one or more pre-trained hierarchical algorithms 901, each of which transforms the reference picture, or part of the reference picture, into a transformed reference picture that is enhanced for use in the motion compensation 119 and/or motion estimation 117 processes. The non-transformed image can also be used in the motion estimation 117 and motion compensation 119 processes. The transformed images are input into the motion estimation 117 and motion compensation 119 processes, which can make them more computationally efficient. The encoder can signal if and which hierarchical algorithm 901 has been used to transform the reference picture.

The hierarchical algorithms 901 used in this process can be selected from a library of pre-trained hierarchical algorithms that are stored in a library. The hierarchical algorithms are trained on pairs of known input pictures and reference pictures to produce a mathematically optimised reference picture, which in general is different to the visually optimised picture. The hierarchical algorithms can be selected from the library based on comparing metric data relating to the input picture 101 currently being encoded with metric data relating to the pictures on which the hierarchical algorithms were trained.

In any of the embodiments described above it is possible to output a predicted block or transformed reference picture block that is in a different space, such as a different feature space, than visual data. The block can then be converted to a block of visual data using a further hierarchical algorithm. Alternatively, the reference pictures and input visual data can be transformed to this different feature space in order to perform the motion compensation process.

Any system feature as described herein may also be provided as a method feature, and vice versa. As used herein, means plus function features may be expressed alternatively in terms of their corresponding structure.

Any feature in an aspect described herein may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

Particular combinations of the various features described or defined herein can be implemented and/or supplied and/or used independently.

Some of the example embodiments are described as processes or methods depicted as diagrams. Although the diagrams describe the operations as sequential processes, operations may be performed in parallel, or concurrently or simultaneously. In addition, the order or operations may be re-arranged. The processes may be terminated when their operations are completed, but may also have additional steps not included in the figures. The processes may correspond to methods, functions, procedures, subroutines, subprograms, etc.

Methods discussed above, some of which are illustrated by the diagrams, may be implemented by hardware, software, firmware, middleware, microcode, hardware description languages, or any combination thereof. When implemented in software, firmware, middleware or microcode, the program code or code segments to perform the relevant tasks may be stored in a machine or computer readable medium such as a storage medium. A processing apparatus may perform the relevant tasks.

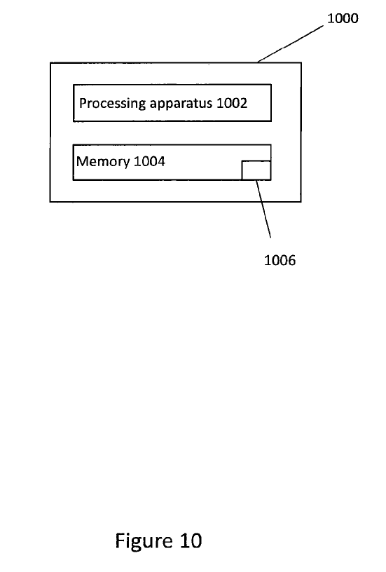

FIG. 10 shows an apparatus 1000 comprising a processing apparatus 1002 and memory 1004 according to an exemplary embodiment. Computer-readable code 1006 may be stored on the memory 1004 and may, when executed by the processing apparatus 1002, cause the apparatus 1000 to perform methods as described here, for example a method with reference to FIGS. 5 to 9.

The processing apparatus 1002 may be of any suitable composition and may include one or more processors of any suitable type or suitable combination of types. Indeed, the term “processing apparatus” should be understood to encompass computers having differing architectures such as single/multi-processor architectures and sequencers/parallel architectures. For example, the processing apparatus may be a programmable processor that interprets computer program instructions and processes data. The processing apparatus may include plural programmable processors. Alternatively, the processing apparatus may be, for example, programmable hardware with embedded firmware. The processing apparatus may alternatively or additionally include Graphics Processing Units (GPUs), or one or more specialised circuits such as field programmable gate arrays FPGA, Application Specific Integrated Circuits (ASICs), signal processing devices etc. In some instances, processing apparatus may be referred to as computing apparatus or processing means.

The processing apparatus 1002 is coupled to the memory 1004 and is operable to read/write data to/from the memory 1004. The memory 1004 may comprise a single memory unit or a plurality of memory units, upon which the computer readable instructions (or code) is stored. For example, the memory may comprise both volatile memory and non-volatile memory. In such examples, the computer readable instructions/program code may be stored in the non-volatile memory and may be executed by the processing apparatus using the volatile memory for temporary storage of data or data and instructions. Examples of volatile memory include RAM, DRAM, and SDRAM etc. Examples of non-volatile memory include ROM, PROM, EEPROM, flash memory, optical storage, magnetic storage, etc.

An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Methods described in the illustrative embodiments may be implemented as program modules or functional processes including routines, programs, objects, components, data structures, etc., that perform particular tasks or implement particular functionality, and may be implemented using existing hardware. Such existing hardware may include one or more processors (e.g. one or more central processing units), digital signal processors (DSPs), application-specific-integrated-circuits, field programmable gate arrays (FPGAs), computers, or the like.

Unless specifically stated otherwise, or as is apparent from the discussion, terms such as processing or computing or calculating or determining or the like, refer to the actions and processes of a computer system, or similar electronic computing device. Note also that software implemented aspects of the example embodiments may be encoded on some form of non-transitory program storage medium or implemented over some type of transmission medium. The program storage medium may be magnetic (e.g. a floppy disk or a hard drive) or optical (e.g. a compact disk read only memory, or CD ROM), and may be read only or random access. Similarly the transmission medium may be twisted wire pair, coaxial cable, optical fibre, or other suitable transmission medium known in the art. The example embodiments are not limited by these aspects in any given implementation.

Further implementations are summarized in the following examples:

### EXAMPLE 1

A method for motion compensation in video data using hierarchical algorithms, the method comprising the steps of:

receiving one or more original blocks of video data and one or more reference blocks of video data;

determining, using one or more hierarchical algorithms, one or more predicted blocks of video data from the one or more reference blocks of video data; and

calculating one or more residual blocks of video data from the one or more predicted blocks of video data and the one or more original blocks of video data.

### EXAMPLE 2

A method for motion compensation in video data using hierarchical algorithms, the method comprising steps of:

receiving one or more residual blocks of video data and one, two or more reference blocks of video data;

determining, using one or more hierarchical algorithms, one or more predicted blocks of video data from the one, two or more reference blocks of video data; and

calculating one or more original blocks of video data from the one or more predicted blocks of video data and the one or more residual blocks of video data.

### EXAMPLE 3

A method according to example 2, further comprising the additional step of receiving metadata identifying the one or more hierarchical algorithms to be used.

### EXAMPLE 4

A method according to any preceding example, wherein the one or more hierarchical algorithms are selected from a library of hierarchical algorithms based on properties of the one or more of reference blocks of video data.

### EXAMPLE 5

A method according to any preceding example, wherein the one or more reference blocks of video data are determined from one or more reference frames of video data.

### EXAMPLE 6

A method according to example 5, wherein a motion vector is used to determine the one or more reference blocks of video data from the one or more reference frames of video data.

### EXAMPLE 7

A method according to any of examples 5 or 6, wherein the one or more reference blocks of video data are determined using at least one of: translational motion estimation;

affine motion estimation; style transform, or warping.

### EXAMPLE 8

A method according to any preceding example, wherein the one or more reference blocks of video data comprises a plurality of reference blocks of visual data.

### EXAMPLE 9

A method according to example 8, wherein the step of determining the one or more predicted blocks of visual data comprises combining, using the one or more hierarchical algorithms, at least two of the plurality of reference blocks of video data.

### EXAMPLE 10

A method according to examples 8 or 9, wherein at least two of the plurality of reference blocks of video data are each selected from a different reference frame of video data.

### EXAMPLE 11

A method according to any of examples 8 to 10, wherein the one or more hierarchical algorithms comprises two or more separate hierarchical algorithms that are applied to each of the plurality of reference blocks of video data to transform the one or more reference blocks of video data to the one or more predicted blocks of video data.

### EXAMPLE 12

A method according to example 11, wherein at least two of the separate hierarchical algorithms applied to each of the plurality of reference blocks of video data are identical.

### EXAMPLE 13

A method according to example 11, wherein at least two of the separate hierarchical algorithms applied to each of the plurality of reference blocks of video data are different.

### EXAMPLE 14

A method according to any of examples 11 to 13, wherein the two or more separate hierarchical algorithms are chosen from a library of hierarchical algorithms based on properties of the plurality of reference blocks of video data.

### EXAMPLE 15

A method according to any of examples 11 to 14, wherein at least one further hierarchical algorithm is applied to an output of the separate hierarchical algorithms to determine the predicted block of visual data.

### EXAMPLE 16

A method according to any preceding example, wherein the step of determining the one or more predicted blocks of video data comprises a step of transforming, using the one or more hierarchical algorithms, the one or more reference blocks of video data to one or more transformed blocks of video data.

### EXAMPLE 17

A method according to example 16, wherein the predicted block of video data is determined from the transformed block of video data.

### EXAMPLE 18

A method according to example 17, wherein one or more additional hierarchical algorithms is used to determine the predicted block of video data from the transformed block of video data.

### EXAMPLE 19

A method according to any preceding example, wherein the one or more hierarchical algorithms were developed using a learned approach.

### EXAMPLE 20

A method according to example 19, wherein the learned approach comprises training the hierarchical algorithm on one or more known predicted blocks of video data and one or more known reference blocks of video data to minimise a difference between the outputs of the hierarchical algorithm and the known original blocks of video data.

### EXAMPLE 21

A method according to any preceding example, wherein the one or more hierarchical algorithms comprise at least one of: a nonlinear hierarchical algorithm; a neural network; a convolutional neural network; a layered algorithm; a recurrent neural network; a long short-term memory network; a multi-dimensional convolutional network; a memory network; or a gated recurrent network.

### EXAMPLE 22

A method according to any preceding example, wherein the method is performed at a node within a network.

### EXAMPLE 23

A method according to any preceding example, wherein the method is performed as part of a video encoding or decoding process.

### EXAMPLE 24

A method according to any preceding example, wherein the one or more predicted blocks of visual data is a single predicted block of visual data.

### EXAMPLE 25

A method substantially as hereinbefore described in relation to FIGS. 5 to 8.

### EXAMPLE 26

Apparatus comprising:

at least one processor;

at least one memory including computer program code which, when executed by the at least one processor, causes the apparatus to perform the method of any one of examples 1 to 25.

### EXAMPLE 27

A computer readable medium having computer readable code stored thereon, the computer readable code, when executed by at least one processor, causing the performance of the method of any one of examples 1 to 25.

### EXAMPLE 28

A method of enhancing reference frames of video data for use in motion compensation using hierarchical algorithms, the method comprising the steps of:

receiving one or more reference frames of video data from a reference buffer;

transforming, using one or more hierarchical algorithms, one or more reference blocks of video data in the one or more reference frames of video data to produce one or more transformed frames of video data, such that the transformed frames of video data are enhanced for motion compensation; and

outputting the one or more transformed frames of video data.

### EXAMPLE 29

A method according to example 28, wherein a plurality of hierarchical algorithms is applied to the one or more reference frames of video data.

### EXAMPLE 30

A method according to example 29, wherein two or more hierarchical algorithms from the plurality of hierarchical algorithms share one or more layers.

### EXAMPLE 31

A method according to any of examples 28 to 30, wherein the transformed frames of video data are used in a motion estimation process.

### EXAMPLE 32

A method according to any of examples 28 to 31, wherein the transformed frames are used in a motion compensation process.

### EXAMPLE 33

A method according to any of examples 28 to 32, wherein the one or more hierarchical algorithms comprise at least one of: a nonlinear hierarchical algorithm; a neural network; a convolutional neural network; a layered algorithm; a recurrent neural network; a long short-term memory network; a multi-dimensional convolutional network; a memory network; or a gated recurrent network.

### EXAMPLE 34

A method according to any of examples 28 to 33, wherein the method is performed as part of a video encoding process.

### EXAMPLE 35

A method according to any of examples 28 to 34, wherein the method is performed at a network node within a network.

### EXAMPLE 36

A method according to any of examples 28 to 35, wherein the one or more hierarchical algorithms were developed using a learned approach.

### EXAMPLE 37

A method according to example 36, wherein the hierarchical algorithm is trained on one or more sub-optimal reference frames and corresponding known reference frames to produce a mathematically optimised reference picture.

### EXAMPLE 38

A method substantially as hereinbefore described in relation to FIG. 9.

### EXAMPLE 39

Apparatus comprising:

at least one processor;

at least one memory including computer program code which, when executed by the at least one processor, causes the apparatus to perform the method of any one of examples 28 to 38.

### EXAMPLE 40

A computer readable medium having computer readable code stored thereon, the computer readable code, when executed by at least one processor, causing the performance of the method of any one of examples 28 to 38.

What is claimed is:

1. A method for motion compensation in video data using hierarchical algorithms, the method comprising steps of:
receiving one or more residual blocks of video data and one, two or more reference blocks of video data;
determining, using one or more hierarchical algorithms, one or more predicted blocks of video data from the one, two or more reference blocks of video data; and
calculating one or more original blocks of video data from the one or more predicted blocks of video data and the one or more residual blocks of video data.

2. The method according to claim 1, wherein the one or more reference blocks of video data are determined from one or more reference frames of video data.

3. The method according to claim 2, wherein a motion vector is used to determine the one or more reference blocks of video data from the one or more reference frames of video data.

4. The method according to claim 2, wherein the one or more reference blocks of video data are determined using at least one selected from the group consisting of: translational motion estimation; affine motion estimation; style transform, and warping.

5. The method according claim 1, wherein the one or more reference blocks of video data comprises a plurality of reference blocks of visual data.

6. The method according to claim 5, wherein the step of determining the one or more predicted blocks of visual data comprises combining, using the one or more hierarchical algorithms, at least two of the plurality of reference blocks of video data.

7. The method according to claim 5, wherein at least two of the plurality of reference blocks of video data are each selected from a different reference frame of video data.

8. The method according to claim 5, wherein the one or more hierarchical algorithms comprises two or more separate hierarchical algorithms that are applied to each of the plurality of reference blocks of video data to transform the one or more reference blocks of video data to the one or more predicted blocks of video data.

9. The method according to claim 8, wherein at least two of the separate hierarchical algorithms applied to each of the plurality of reference blocks of video data are identical.

10. The method according to claim 8, wherein at least two of the separate hierarchical algorithms applied to each of the plurality of reference blocks of video data are different.

11. The method according to claim 8, wherein the two or more separate hierarchical algorithms are chosen from a library of hierarchical algorithms based on properties of the plurality of reference blocks of video data.

12. The method according to claim 8, wherein at least one further hierarchical algorithm is applied to an output of the separate hierarchical algorithms to determine the predicted block of visual data.

13. The method according to claim 1, wherein the step of determining the one or more predicted blocks of video data comprises a step of transforming, using the one or more hierarchical algorithms, the one or more reference blocks of video data to one or more transformed blocks of video data.

14. The method according to claim 13, wherein the predicted block of video data is determined from the transformed block of video data.

15. A computer readable medium having computer readable code stored thereon, the computer readable code, when executed by at least one processor, causing the performance of a method including:
receiving one or more residual blocks of video data and one, two or more reference blocks of video data;
determining, using one or more hierarchical algorithms, one or more predicted blocks of video data from the one, two or more reference blocks of video data; and
calculating one or more original blocks of video data from the one or more predicted blocks of video data and the one or more residual blocks of video data.

16. A method of enhancing reference frames of video data for use in motion compensation using hierarchical algorithms, the method comprising the steps of:
receiving one or more reference frames of video data from a reference buffer;
transforming, using one or more hierarchical algorithms, one or more reference blocks of video data in the one or more reference frames of video data to produce one or more transformed frames of video data, such that the transformed frames of video data are enhanced for motion compensation; and
outputting the one or more transformed frames of video data.

17. The method according to claim 16, wherein a plurality of hierarchical algorithms is applied to the one or more reference frames of video data.

18. The method according to claim 17, wherein two or more hierarchical algorithms from the plurality of hierarchical algorithms share one or more layers.

19. The method according to claim 16, wherein the one or more hierarchical algorithms were developed using a learned approach.

20. The method according to claim 19, wherein the hierarchical algorithm is trained on one or more sub-optimal reference frames and corresponding known reference frames to produce a mathematically optimised reference picture.
